(19) United States
(12) Patent Application Publication
(10) Pub. No.: US 2025/0364200 A1
(43) Pub. Date: Nov. 27, 2025

(54) ELECTRON SOURCE, ELECTRONIC DEVICE, AND ELECTRON EMISSION METHOD

(71) Applicant: Kabushiki Kaisha Toshiba, Tokyo (JP)

(72) Inventors: Shigeya KIMURA, Yokohama Kanagawa (JP); Hisao MIYAZAKI, Yokohama Kanagawa (JP); Shinya NUNOUE, Ichikawa Chiba (JP)

(21) Appl. No.: 19/034,026

(22) Filed: Jan. 22, 2025

(30) Foreign Application Priority Data
May 24, 2024 (JP) 2024-084807

(51) Int. Cl. H01J 3/02

(52) U.S. Cl. CPC H01J 3/021

(57) ABSTRACT

According to one embodiment, an electron source includes a first member, a first light emitting portion, and a second light emitting portion. The first member includes a first region and a second region. The first region includes InₓAl_{y}Ga_{1-x-y}N (0≤x≤1, 0≤y≤1, x+y≤1). The second region includes diamond. The first light emitting portion is configured to emit a first light having a first peak wavelength into the first member. The second light emitting portion is configured to emit a second light having a second peak wavelength shorter than the first peak wavelength to the first member.

### CROSS-REFERENCE TO RELATED APPLICATIONS

This application is based upon and claims the benefit of priority from Japanese Patent Application No. 2024-084807, filed on May 24, 2024; the entire contents of which are incorporated herein by reference.

### FIELD

Embodiments described herein relate generally to an electron source, an electronic device, and an electron emission method.

### BACKGROUND

For example, electrons emitted from an electron source are applied to various electronic devices. It is desired to improve the characteristics of electron sources.

### BRIEF DESCRIPTION OF THE DRAWINGS

FIG. 1 is a schematic cross-sectional view illustrating an electron source according to a first embodiment;

FIG. 2 is a schematic cross-sectional view illustrating a part of the electron source according to the first embodiment;

FIG. 3 is a schematic cross-sectional view illustrating a part of the electron source according to the first embodiment;

FIG. 4 is a schematic cross-sectional view illustrating a part of the electron source according to the first embodiment;

FIG. 5 is a schematic diagram illustrating the electron source according to the first embodiment;

FIG. 6 is a schematic cross-sectional view illustrating an electron source according to the first embodiment;

FIG. 7 is a schematic cross-sectional view illustrating an electron source according to the first embodiment;

FIG. 8 is a schematic cross-sectional view illustrating an electron source according to the first embodiment; and

FIG. 9 is a schematic diagram illustrating an electronic device according to a second embodiment.

### DETAILED DESCRIPTION

According to one embodiment, an electron source includes a first member, a first light emitting portion, and a second light emitting portion. The first member includes a first region and a second region. The first region includes InₓAl_{y}Ga_{1-x-y}N (0≤x≤1, 0≤y≤1, x+y≤1). The second region includes diamond. The first light emitting portion is configured to emit a first light having a first peak wavelength into the first member. The second light emitting portion is configured to emit a second light having a second peak wavelength shorter than the first peak wavelength to the first member.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

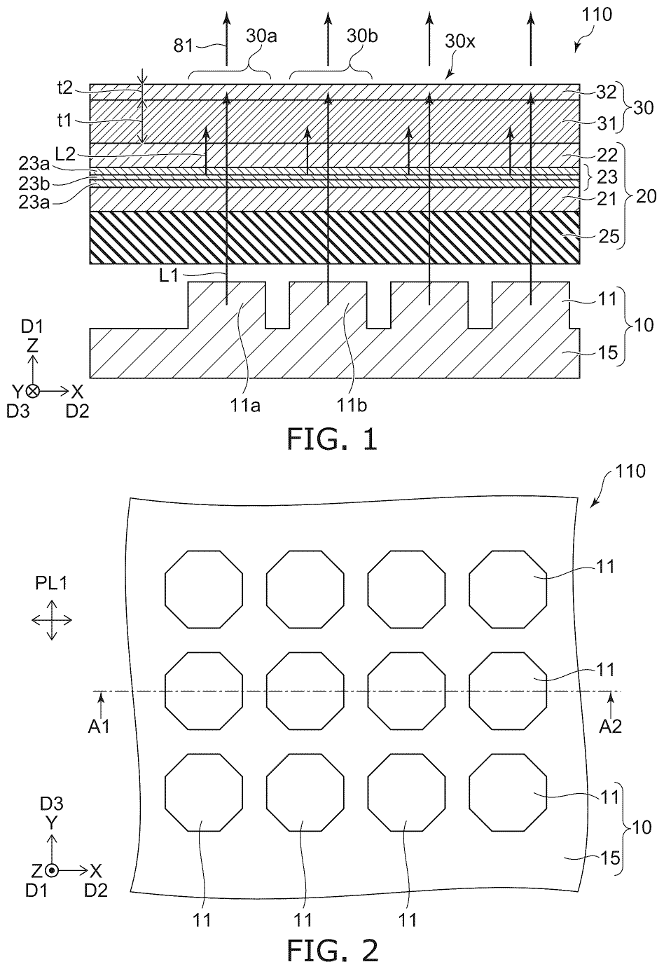

FIG. 1 is a schematic cross-sectional view illustrating an electron source according to a first embodiment.

FIG. 2 is a schematic cross-sectional view illustrating a part of the electron source according to the first embodiment. FIG. 1 corresponds to a sectional view taken along the line A1-A2 in FIG. 2.

As shown in FIG. 1, an electron source 110 according to the embodiment includes a first member 30, a first light emitting portion 10, and a second light emitting portion 20. FIG. 2 illustrates a planar pattern of the first light emitting portion 10.

As shown in FIG. 1, the first member 30 includes a first region 31 and a second region 32. The first region 31 includes, for example, nitride. The nitride may include Ga. In one example, the first region 31 includes InₓAl_{y}Ga1_{-x-y}N (0≤x≤1, 0≤y≤1, x+y≤1). The first region 31 may include crystal, for example.

The second region 32 includes diamond.

The first light emitting portion 10 is configured to cause a first light L1 having a first peak wavelength to enter the first member 30. The second light emitting portion 20 is configured to cause a second light L2 having a second peak wavelength to enter the first member 30. The second peak wavelength is shorter than the first peak wavelength.

In one example, the second light L2 includes, for example, ultraviolet light or blue light. For example, the first light L1 includes yellow light or red light.

In the electron source 110, the first light L1 and the second light L2 enter the first member 30. As a result, electrons 81 are emitted from the second region 32 with high efficiency. For example, in the first region 31, at least a part of this light is absorbed to generate movable electrons 81. The electrons 81 move from the first region 31 to the second region 32 and are emitted from the second region 32 to the outside space. Highly efficient electron emission can be obtained. According to the embodiment, an electron source whose characteristics can be improved can be provided.

For example, in the electron source of a first reference example, a material such as cesium is used as an electron emitting material. In this case, high efficiency can be easily obtained. However, in the first reference example, the life of the electron source is short.

In contrast, in embodiments, stable diamond is used. As a result, high efficiency can be stably obtained. A long lifetime can be obtained.

In a second reference example, a diamond layer is used as the electron emission layer. In the second reference example, the first region 31 described above is not provided. In such a second reference example, extremely high energy is required to cause the diamond to emit electrons. For example, a method using deep ultraviolet rays can be considered, but it is practically difficult to obtain deep ultraviolet rays stably with high efficiency. In the deep ultraviolet ray, the wavelength is, for example, less than 230 nm.

In the embodiment, in addition to the second region 32 including diamond, the first region 31 including nitride is provided. The first region 31 assists the second region 32, for example. In the embodiment, electrons can be emitted from the second region 32 with high efficiency without using deep ultraviolet rays. In the embodiment, ultraviolet ray (or light) with a wavelength of 230 nm or more may be used.

In the embodiment, two lights (first light L1 and second light L2) with different wavelengths are used. For example, photoelectric conversion occurs in the first region 31 due to the second light L2, and movable electrons are generated. Electrons in the first region 31 move with high efficiency from the first region 31 to the second region 32 by the first light L1. Electrons are emitted from the surface of the second region 32 to the outside.

In the embodiment, the first region 31 functions as a light absorption region, for example. The second region 32 functions as an electron emission region.

In the embodiment, the first peak wavelength may be, for example, not less than 450 nm and not more than 1000 nm. The second peak wavelength may be, for example, not less than 230 nm and not more than 450 nm.

In the example shown in FIG. 1, the second light emitting portion 20 is provided between the first light emitting portion 10 and the second region 32 in a first direction D1. The first region 31 is provided between the second light emitting portion 20 and the second region 32 in the first direction D1.

The first direction D1 is defines as a Z-axis direction. One direction perpendicular to the Z-axis direction is defined as an X-axis direction. A direction perpendicular to the Z-axis direction and the X-axis direction is defined as a Y-axis direction.

The first region 31 is, for example, layered along the X-Y plane. The second region 32 does not need to be a continuous film. The second region 32 may have an island shape or a mesh shape.

In the example shown in FIG. 1, the first light L1 having long wavelength passes through the second light emitting portion 20 and enters the first member 30. In the embodiment, the first light L1 may enter the first member 30 without passing through the second light emitting portion 20.

The first peak wavelength of the first light L1 is longer than the second peak wavelength of the second light L2. The first light L1 may reach the second region 32 with a small degree of attenuation, for example. At least a part of the first light L1 may pass through the first region 31 with high efficiency. High efficiency can be obtained.

For example, the first light emitting portion 10 and the second light emitting portion 20 may be provided to be arranged in the X-Y plane.

As shown in FIG. 1, the first light emitting portion 10 may include a plurality of light emitting regions 11. The plurality of light emitting regions 11 are configured to emit the first light L1.

The plurality of light emitting regions 11 may be connected to a first base 15, for example. At least parts of the plurality of light emitting regions 11 may be arranged along a second direction D2 crossing the first direction D1. The second direction D2 may be, for example, the X-axis direction.

As shown in FIG. 2, the plurality of light emitting regions 11 may be two-dimensionally arranged along a first plane PL1 crossing the first direction D1. The plurality of light emitting regions 11 may be arranged along the second direction D2 and a third direction D3, for example. For example, the third direction D3 crosses a plane including the first direction D1 and the second direction D2. The third direction D3 may be, for example, the Y-axis direction. The third direction D3 may be inclined with respect to the second direction D2.

At least a part of the plurality of light emitting regions 11 may include a laser. For example, at least a part of the plurality of light emitting regions 11 may include a surface emitting laser. The surface emitting laser may include, for example, a VCSEL (Vertical Cavity Surface Emitting Laser). Thereby, the first light L1 with high intensity and small luminous flux is obtained. Electrons can be emitted from desired locations with high efficiency.

For example, the first member 30 may include a plurality of partial regions 30x. One of the plurality of partial regions 30x overlaps one of the plurality of light emitting regions 11. Electrons 81 are emitted from each of the plurality of partial regions 30x corresponding to the plurality of light emitting regions 11.

For example, the first member 30 includes a first partial region 30a and a second partial region 30b. The plurality of light emitting regions 11 include a first light emitting region 11a and a second light emitting region 11b. The first partial region 30a overlaps the first light emitting region 11a in the first direction D1. The second partial region 30b overlaps the second light emitting region 11b in the first direction D1.

For example, in a first operation, the first light L1 is emitted from the first light emitting region 11a, and the electrons 81 are emitted from the first partial region 30a. In a second operation, the first light L1 is emitted from the second light emitting region 11b, and electrons 81 are emitted from the second partial region 30b.

For example, in the first operation, the first light L1 may not be emitted from the second light emitting region 11b, and the electrons 81 may not be emitted from the second partial region 30b. In the second operation, the first light L1 may not be emitted from the first light emitting region 11a, and the electrons 81 may not be emitted from the first partial region 30a. The first light L1 may be selectively emitted from one of the plurality of light emitting regions 11.

The first light L1 may be emitted from at least two of the plurality of light emitting regions 11 at the same time.

As shown in FIG. 1, the second light emitting portion 20 may include a first semiconductor layer 21, a second semiconductor layer 22, and a light emitting layer 23. The first semiconductor layer 21 is of a first conductivity type. The second semiconductor layer 22 is of a second conductivity type. The second semiconductor layer 22 is provided between the first semiconductor layer 21 and the first member 30. The light emitting layer 23 is provided between the first semiconductor layer 21 and the second semiconductor layer 22. The first conductivity type is, for example, one of an n-type and a p-type. The second conductivity type is the other of the n-type and the p-type.

For example, the light emitting layer 23 may include a plurality of barrier layers 23a and a well layer 23b provided between the plurality of barrier layers 23a.

The first semiconductor layer 21 includes, for example, Ga and N. The first semiconductor layer 21 may further include Si. The second semiconductor layer 22 includes, for example, Ga and N. The second semiconductor layer 22 may further include Mg. The barrier layer 23a includes, for example, Al, Ga, and N. The barrier layer 23a includes, for example, In, Ga, and N. The compositions of these layers can be varied in various ways. The second light emitting portion 20 may be, for example, an LED. The second light emitting portion 20 may include, for example, a second base 25. The first semiconductor layer 21 is provided between the second base 25 and the second semiconductor layer 22. The second base 25 may be, for example, a substrate (such as a sapphire substrate).

As shown in FIG. 1, the second region 32 may be in contact with the first region 31.

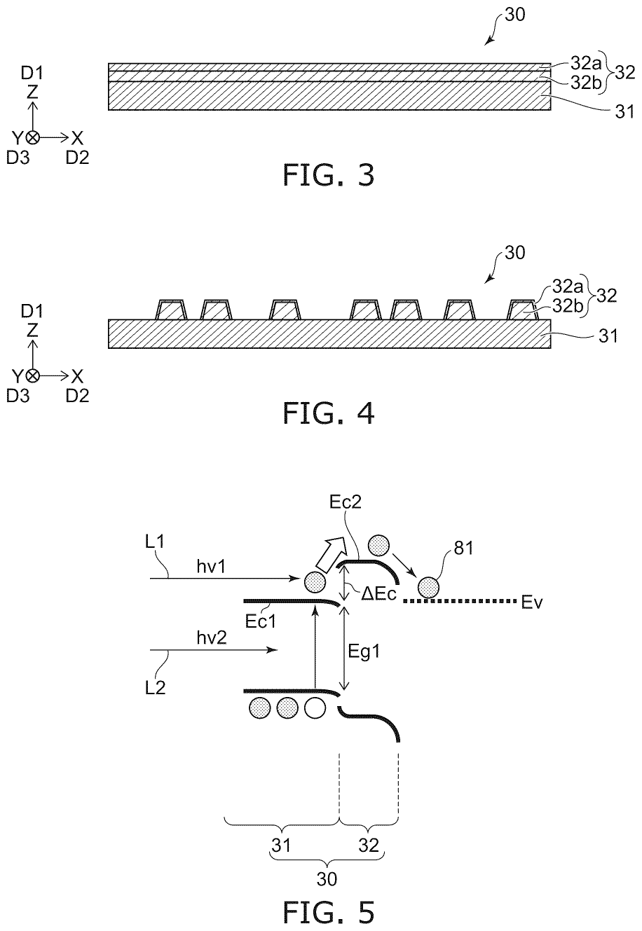

FIG. 3 is a schematic cross-sectional view illustrating a part of the electron source according to the first embodiment.

FIG. 3 illustrates the first member 30. As shown in FIG. 3, the second region 32 may include a surface region 32a and a non-surface region 32b. The non-surface region 32b is provided between the first region 31 and the surface region 32a. The surface region 32a includes carbon and hydrogen. The non-surface region 32b does not include hydrogen. Alternatively, a concentration of hydrogen in the non-surface region 32b is lower than a concentration of hydrogen in the surface region 32a. The surface region 32a is a hydrogen-terminated region. More stable and highly efficient electron emission can be obtained. For example, surface region 32a includes carbon and hydrogen bonds.

FIG. 4 is a schematic cross-sectional view illustrating a part of the electron source according to the first embodiment.

FIG. 4 illustrates the first member 30. As shown in FIG. 4, the second region 32 may have an island shape or a mesh shape. For example, a large surface area is obtained in the second region 32. Electron emission with higher efficiency can be obtained.

In the embodiment, the second region 32 may include at least one selected from the group consisting of boron and aluminum. The second region 32 may include, for example, p-type diamond. Higher efficiency can be obtained.

As shown in FIG. 1, a second thickness t2 of the second region 32 is preferably thinner than a first thickness t1 of the first region 31. The second region 32 being thin facilitates electron emission with higher efficiency.

In one example, the second thickness t2 is less than 10 nm. The first thickness t1 is not less than 10 nm and not more than 100 nm.

For example, the first thickness t1 may be not less than 5 nm and not more than 100 nm. The first thickness t1 may be not less than 10 nm and not more than 50 nm.

For example, the second thickness t2 (average value) may be not less than 0.05 nm and not more than 30 nm. The second thickness t2 (average value) may be not less than 0.05 nm and not more than 5 nm.

FIG. 5 is a schematic diagram illustrating the electron source according to the first embodiment.

FIG. 5 illustrates the energy state in the first member 30. As shown in FIG. 5, the first member 30 includes the first region 31 and the second region 32. As already explained, the first light emitting portion 10 is configured to cause the first light L1 having the first peak wavelength to enter the first member 30. The second light emitting portion 20 is configured to cause the second light L2 having the second peak wavelength shorter than the first peak wavelength to enter the first member 30.

As shown in FIG. 5, a second conduction band energy Ec2 of the second region 32 is higher than a first conduction band energy Ec1 of the first region 31. A difference between the second conduction band energy Ec2 and the first conduction band energy Ec1 is defined as a difference ΔEc. The difference ΔEc corresponds to the barrier difference.

A first energy hv1 of the first light L1 is larger than an absolute value of the difference ΔEc between the second conduction band energy Ec2 and the first conduction band energy Ec1. A second energy hv2 of the second light L2 is larger than a bandgap energy Eg1 of the first region 31.

For example, electrons 81 are obtained in the first region 31 by the second light L2 having the second energy hv2 larger than the band gap energy Eg1 of the first region 31. For example, the electrons 81 move beyond the barrier to the second region 32 due to the first light L1 having the first energy hv1 larger than the absolute value of the difference ΔEc (barrier difference). Electrons 81 are emitted from the surface of second region 32 to the outside. In FIG. 5, for example, electrons 81 are emitted toward a space of the vacuum level Ev. According to embodiments, electron emission is obtained with high efficiency.

For example, the second energy hv2 is greater than the first energy hv1.

For example, carriers are excited by the second light L2. The first light L1 promotes electron emission. The first light emitting portion 10 that emits the first light L1 may include, for example, a visible light VCSEL. For example, a highly convergent electron beam can be obtained. An electron beam with small energy dispersion can be obtained. For example, a highly efficient electron beam can be obtained. A long lifetime can be obtained. At least a part of the two light emitting portions may not be provided in the reduced pressure container. A simple structure can be obtained. According to the embodiment, an electron source with improved characteristics is provided.

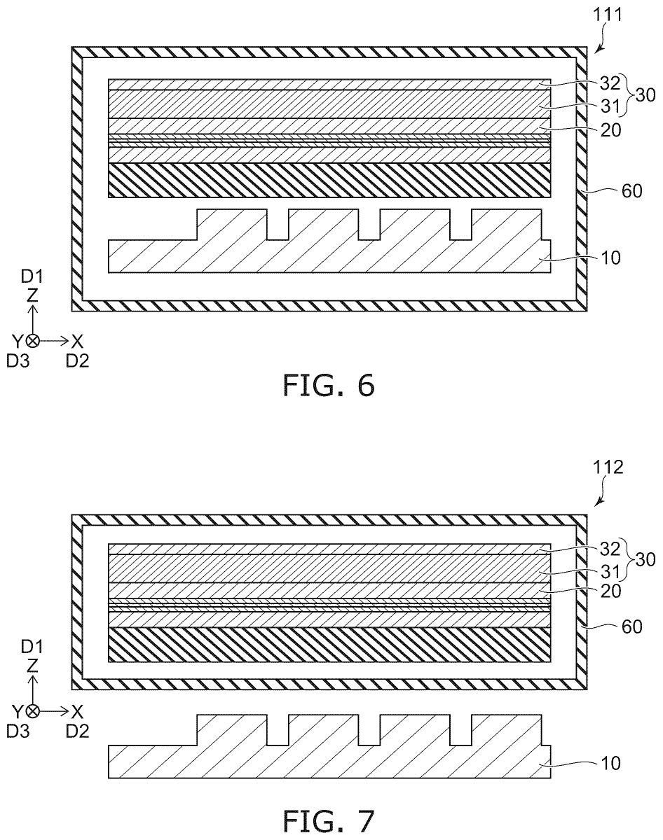

FIGS. 6 to 8 are schematic cross-sectional views illustrating electron source according to the first embodiment. As shown in FIGS. 6 to 8, electron sources 111 to 113 according to the embodiment include a container 60. The configurations of the electron sources 111 to 113 except for this may be the same as the configurations of the electron source 110 and its modifications.

In the electron source 111, the first member 30 is provided inside the container 60. The inside of the container 60 has a pressure lower than 1 atmosphere. At least one of the second light emitting portion 20 and the first light emitting portion 10 may be provided inside the container 60.

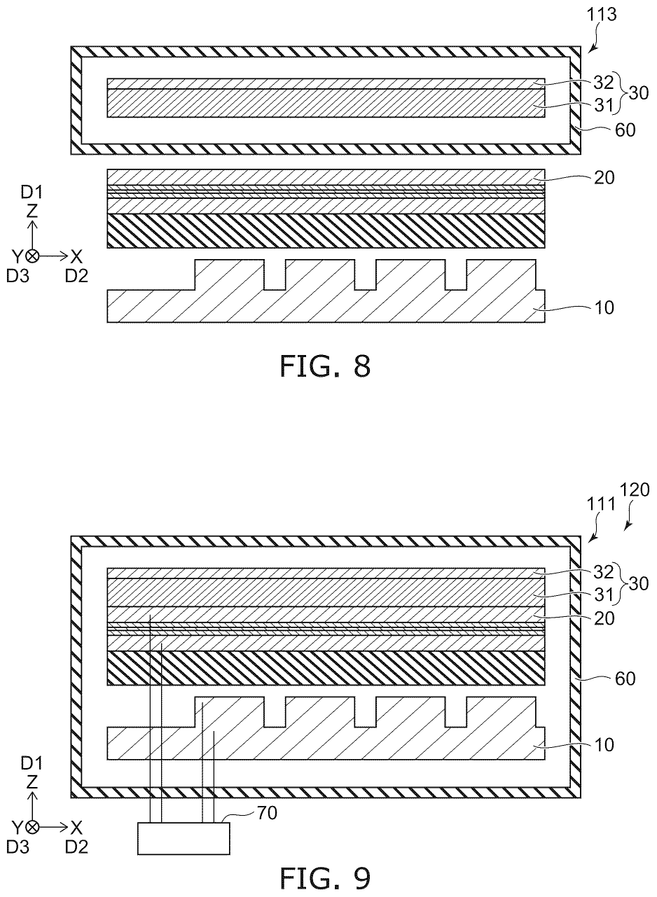

As shown in FIG. 7, in the electron source 112 according to the embodiment, the second light emitting portion 20 is provided inside the container 60. The first light emitting portion 10 is provided outside the container 60. As shown in FIG. 8, in the electron source 113 according to the embodiment, the second light emitting portion 20 and the first light emitting portion 10 are provided outside the container 60.

### Second Embodiment

FIG. 9 is a schematic diagram illustrating an electronic device according to a second embodiment.

As shown in FIG. 9, an electronic device 120 according to the embodiment includes the electron source according to the first embodiment (in this example, the electron source 111) and the control circuit 70. The control circuit 70 is configured to control the electron source (in this example, electron source 111).

The electronic device 120 may include, for example, at least one selected from the group consisting of a sensor, a switch device, an electron beam lithography device, a processing device, and an analysis device. An electronic device whose characteristics can be improved is provided. The sensor may include, for example, a light sensor and the like. The analysis device may include, for example, an electron microscope.

### Third Embodiment

The third embodiment relates to an electron emission method. The electron emission method includes, for example, making the first light L1 and the second light L2 to be incident on the first member 30 including the first region 31 and the second region 32 to cause the first member 30 to emit electrons. The first region 31 includes, for example, InₓAl_{y}Ga_{1-x-y}N (0≤x≤1, 0≤y≤1, x+y≤1). The second region 32 includes diamond. The first light L1 has a first peak wavelength. The second light L2 has a second peak wavelength shorter than the first peak wavelength. According to the embodiment, highly efficient electron emission is obtained. In the third embodiment, the configuration described in relation to the first embodiment may be applied. A method for emitting electrons that can improve properties is provided.

The electron emission method includes, for example, causing the first light L1 and the second light L2 to enter the first member 30 including the first region 31 and the second region 32 to cause the first member 30 to emit electrons. The first light L1 has the first peak wavelength. The second light L2 has the second peak wavelength shorter than the first peak wavelength. The second conduction band energy Ec2 of the second region 32 is higher than the first conduction band energy Ec1 of the first region 31. The first energy hv1 of the first light L1 is larger than the absolute value of the difference ΔEc between the second conduction band energy Ec2 and the first conduction band energy Ec1. The second energy hv2 of the second light L2 is larger than the bandgap energy Eg1 of the first region 31. A method for emitting electrons that can improve properties is provided.

Information regarding length and thickness can be obtained by electron microscopy, etc. Information regarding the composition of the material can be obtained by SIMS (Secondary Ion Mass Spectrometry), TEM (Transmission Electron Spectroscopy), EDX (Energy dispersive X-ray spectroscopy), or the like. Based on information regarding the composition of the material, information regarding the energy of the material can be obtained.

The embodiments may include the following Technical proposals:

### (Technical Proposal 1)

An electron source, comprising:
a first member including a first region and a second region, the first region including InₓAl_{y}Ga_{1-x-y}N (0≤x≤1, 0≤y≤1, x+y≤1), the second region including diamond;
a first light emitting portion configured to emit a first light having a first peak wavelength into the first member; and
a second light emitting portion configured to emit a second light having a second peak wavelength shorter than the first peak wavelength to the first member.

### (Technical Proposal 2)

The electron source according to Technical proposal 1, wherein
the first peak wavelength is not less than 450 nm and not more than 1000 nm, and
the second peak wavelength is not less than 230 nm and not more than 450 nm.

### (Technical Proposal 3)

The electron source according to Technical proposal 1 or 2, wherein
the second light emitting portion is provided between the first light emitting portion and the second region in a first direction, and
the first region is provided between the second light emitting portion and the second region in the first direction.

### (Technical Proposal 4)

The electron source according to Technical proposal 3, wherein
the first light emitting portion includes a plurality of light-emitting regions configured to emit the first light, and
at least parts of the plurality of light-emitting regions are arranged along a second direction crossing the first direction.

### (Technical Proposal 5)

The electron source according to Technical proposal 3, wherein
the first light emitting portion includes a plurality of light-emitting regions configured to emit the first light, and
the plurality of light-emitting regions are two-dimensionally arranged along a first plane crossing the first direction.

### (Technical Proposal 6)

The electron source according to Technical proposal 4 or 5, wherein
at least a part of the light emitting regions includes a surface emitting laser.

### (Technical Proposal 7)

The electron source according to Technical proposal 3 or 4, wherein
the first member includes a first partial region and a second partial region,
the plurality of light-emitting regions include a first light-emitting region and a second light-emitting region,
the first partial region overlaps the first light-emitting region in the first direction,
the second partial region overlaps the second light-emitting region in the first direction,
in a first operation, the first light is emitted from the first light-emitting region, and electrons are emitted from the first partial region, and
in a second operation, the first light is emitted from the second light-emitting region, and electrons are emitted from the second partial region.

### (Technical Proposal 8)

The electron source according to Technical proposal 7, wherein
in the first operation, the first light is not emitted from the second light-emitting region, and electrons are not emitted from the second partial region, and
in the second operation, the first light is not emitted from the first light-emitting region, and electrons are not emitted from the first partial region.

### (Technical Proposal 9)

The electron source according to any one of Technical proposals 1-8, wherein
the second light emitting section includes:
   a first semiconductor layer of a first conductivity type;
   a second semiconductor layer of a second conductivity type provided between the first semiconductor layer and the first member; and
   a light emitting layer provided between the first semiconductor layer and the second semiconductor layer.

### (Technical Proposal 10)

The electron source according to Technical proposal 9, wherein
the light emitting layer includes a plurality of barrier layers and a well layer provided between the plurality of barrier layers.

### (Technical Proposal 11)

The electron source according to any one of Technical proposals 1-10, wherein
the second region is in contact with the first region.

### (Technical Proposal 12)

The electron source according to any one of Technical proposals 1-11, wherein
the second region is in an island or mesh shape.

### (Technical Proposal 13)

The electron source according to any one of Technical proposals 1-12, wherein
the second region includes a surface region and a non-surface region,
the non-surface region is provided between the first region and the surface region,
the surface region includes carbon and hydrogen, and
the non-surface region does not include hydrogen or a concentration of hydrogen in the non-surface region is lower than a concentration of hydrogen in the surface region.

### (Technical Proposal 14)

The electron source according to any one of Technical proposals 1-13, wherein the second region includes at least one selected from the group consisting of boron and aluminum.

### (Technical Proposal 15)

The electron source according to any one of Technical proposals 1-14, wherein a second thickness of the second region is less than a first thickness of the first region.

### (Technical Proposal 16)

The electron source according to any one of Technical proposals 1-14, wherein
a second thickness of the second region is 30 nm or less, and
a first thickness of the first region is not less than 10 nm and not more than 100 nm.

### (Technical Proposal 17)

The electron source according to any one of Technical proposals 1-16, further comprising:
a container,
the first member being provided in an inside the container, and
the inside of the container being at a pressure lower than 1 atmosphere.

### (Technical Proposal 18)

An electron source, comprising:
a first member including a first region and a second region;
a first light emitting portion configured to emit a first light having a first peak wavelength into the first member; and
a second light emitting portion configured to emit a second light having a second peak wavelength shorter than the first peak wavelength to the first member,
a second conduction band energy of the second region being higher than a first conduction band energy of the first region,
a first energy of the first light being greater than an absolute value of a difference between the second conduction band energy and the first conduction band energy, and
a second energy of the second light being greater than a band gap energy of the first region.

### (Technical Proposal 19)

An electronic device, comprising:
the electron source according to any one of Technical proposals 1-18; and
a control circuit configured to control the electron source.

### (Technical Proposal 20)

An electron emission method, comprising:
causing a first light and a second light to enter a first member including a first region including InₓAl_{y}Ga_{1-x-y}N (0≤x≤1, 0≤y≤1, x+y≤1) and a second region including diamond to cause the first member to emit electrons,
the first light having a first peak wavelength, and
the second light having a second peak wavelength being shorter than the first peak wavelength.

According to the embodiments, an electron source, an electronic device, and an electron emission method are provided that can improve characteristics.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the electron source and the electronic devices such as members, the light emitting portions, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all electron sources, all electronic devices, and all electron emission methods practicable by an appropriate design modification by one skilled in the art based on the electron sources, the electronic devices, and the electron emission methods described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An electron source, comprising:
a first member including a first region and a second region, the first region including InₓAl_{y}Ga_{1-x-y}N (0≤x≤1, 0≤y≤1, x+y≤1), the second region including diamond;
a first light emitting portion configured to emit a first light having a first peak wavelength into the first member; and
a second light emitting portion configured to emit a second light having a second peak wavelength shorter than the first peak wavelength to the first member.

2. The electron source according to claim 1, wherein
the first peak wavelength is not less than 450 nm and not more than 1000 nm, and
the second peak wavelength is not less than 230 nm and not more than 450 nm.

3. The electron source according to claim 1, wherein
the second light emitting portion is provided between the first light emitting portion and the second region in a first direction, and
the first region is provided between the second light emitting portion and the second region in the first direction.

4. The electron source according to claim 3, wherein
the first light emitting portion includes a plurality of light-emitting regions configured to emit the first light, and
at least parts of the plurality of light-emitting regions are arranged along a second direction crossing the first direction.

5. The electron source according to claim 3, wherein
the first light emitting portion includes a plurality of light-emitting regions configured to emit the first light, and
the plurality of light-emitting regions are two-dimensionally arranged along a first plane crossing the first direction.

6. The electron source according to claim 4, wherein
at least a part of the light emitting regions includes a surface emitting laser.

7. The electron source according to claim 3, wherein
the first member includes a first partial region and a second partial region,
the plurality of light-emitting regions include a first light-emitting region and a second light-emitting region,
the first partial region overlaps the first light-emitting region in the first direction,
the second partial region overlaps the second light-emitting region in the first direction,
in a first operation, the first light is emitted from the first light-emitting region, and electrons are emitted from the first partial region, and
in a second operation, the first light is emitted from the second light-emitting region, and electrons are emitted from the second partial region.

8. The electron source according to claim 7, wherein
in the first operation, the first light is not emitted from the second light-emitting region, and electrons are not emitted from the second partial region, and
in the second operation, the first light is not emitted from the first light-emitting region, and electrons are not emitted from the first partial region.

9. The electron source according to claim 1, wherein
the second light emitting section includes:
a first semiconductor layer of a first conductivity type;
a second semiconductor layer of a second conductivity type provided between the first semiconductor layer and the first member; and
a light emitting layer provided between the first semiconductor layer and the second semiconductor layer.

10. The electron source according to claim 9, wherein
the light emitting layer includes a plurality of barrier layers and a well layer provided between the plurality of barrier layers.

11. The electron source according to claim 1, wherein
the second region is in contact with the first region.

12. The electron source according to claim 1, wherein
the second region is in an island or mesh shape.

13. The electron source according to claim 1, wherein
the second region includes a surface region and a non-surface region,
the non-surface region is provided between the first region and the surface region,
the surface region includes carbon and hydrogen, and
the non-surface region does not include hydrogen or a concentration of hydrogen in the non-surface region is lower than a concentration of hydrogen in the surface region.

14. The electron source according to claim 1, wherein
the second region includes at least one selected from the group consisting of boron and aluminum.

15. The electron source according to claim 1, wherein
a second thickness of the second region is less than a first thickness of the first region.

16. The electron source according to claim 1, wherein
a second thickness of the second region is 30 nm or less, and
a first thickness of the first region is not less than 10 nm and not more than 100 nm.

17. The electron source according to claim 1, further comprising:
a container,
the first member being provided in an inside the container, and
the inside of the container being at a pressure lower than 1 atmosphere.

18. An electron source, comprising:
a first member including a first region and a second region;
a first light emitting portion configured to emit a first light having a first peak wavelength into the first member; and
a second light emitting portion configured to emit a second light having a second peak wavelength shorter than the first peak wavelength to the first member,
a second conduction band energy of the second region being higher than a first conduction band energy of the first region,
a first energy of the first light being greater than an absolute value of a difference between the second conduction band energy and the first conduction band energy, and
a second energy of the second light being greater than a band gap energy of the first region.

19. An electronic device, comprising:
the electron source according to claim 1; and
a control circuit configured to control the electron source.

20. An electron emission method, comprising:
causing a first light and a second light to enter a first member including a first region including InₓAl_{y}Ga_{1-x-y}N (0≤x≤1, 0≤y≤1, x+y≤1) and a second region including diamond to cause the first member to emit electrons,
the first light having a first peak wavelength, and
the second light having a second peak wavelength being shorter than the first peak wavelength.
